(19) United States
(12) Patent Application Publication
(10) Pub. No.: US 2022/0033601 A1
(43) Pub. Date: Feb. 3, 2022

(54) TRANSPARENT POLYMER HARDCOATS WITH ANTIMICROBIAL EFFICACY

(71) Applicant: C3 Nano, Inc., Hayward, CA (US)

(72) Inventors: Faraz Azadi Manzour, Berkeley, CA (US); Alexander Seung-il Hong, Hayward, CA (US); Salman Mansoor Faroqui, Berkeley, CA (US); Xiqiang Yang, Hayward, CA (US); Ajay Virkar, San Mateo, CA (US)

(21) Appl. No.: 17/390,060

(22) Filed: Jul. 30, 2021

Related U.S. Application Data
(60) Provisional application No. 63/059,564, filed on Jul. 31, 2020.

(51) Int. Cl. C08J 7/046; C08L 33/08; C08L 75/14; C08K 3/36; C08K 5/098; B32B 33/00; B32B 27/08; B32B 27/24

(52) U.S. Cl. CPC C08J 7/046; B32B 2457/208; C08L 75/14; C08K 3/36; C08K 5/098; B32B 33/00; B32B 27/08; B32B 27/24; C08L 2201/10; C08L 2203/16; C08L 2203/20; C08K 2201/011; B32B 2307/412; B32B 2307/536; B32B 2307/732; B32B 2255/10; B32B 2255/26; B32B 2333/08; B32B 2375/00; B32B 2379/08; C08L 33/08

(57) ABSTRACT

Transparent polymeric hardcoats with antimicrobial efficacy are described along with compositions for preparing the hardcoats. The transparent polymeric hardcoats at appropriate thicknesses can provide optical properties of high optical transmission, low haze and high clarity, and are suitable for use in electronic displays designed for commercial applications intended for high consumer use. Touch screens having the transparent polymeric hardcoats are also described.

### CROSS REFERENCE TO RELATED APPLICATIONS

This application claims priority to copending U.S. provisional patent application 63/059,564 filed on Jul. 31, 2020 to Manzour et al., entitled “Transparent Polymer Hardcoats With Antimicrobial Efficacy,” incorporated herein by reference.

### BACKGROUND OF THE INVENTION

Displays find widespread usage in various settings and with respect to a growing number of devices as the internet of things becomes more ubiquitous. Transparent structures are used between the light emitting elements and the display surface. A significant number of displays have touch sensors built into the devices that provide for input through touch of the screen. Many displays are found on portable electronic devices, and some can be found on input displays in a variety of public settings, such as menus in eating establishments or information displays in airports, building lobbies and other locations.

At the same time, there is considerable awareness of the spread of diseases in many settings. Thus, personal consumer electronic devices provide concerns over the possibility of carrying diseases. The use of touch screens in public settings provides clear reasons for concerns with potentially a large number of unacquainted individuals touching the screen with a corresponding significant risk of disease spread. The surface of displays can be glass. But for various reasons, other scratch proof polymer surfaces can be presented on the surface of a display either over glass or as a replacement of the glass.

### SUMMARY OF THE INVENTION

The invention pertains to compositions used for preparing transparent polymeric hardcoats with antimicrobial efficacy. The compositions include antimicrobial metal salts of silver and/or copper. Examples include copper (II) nitrate, silver trifluoroacetate, silver tetrafluoroborate, silver hexafluoroantimonate, copper (II) hexafluoroacetylacetonate or combinations thereof. The compositions also include polymeric precursors in organic solvent and are generally radiation or heat curable, forming a crosslinked polymeric network upon film formation. The polymeric precursors may be free of aromatic groups. Nanoparticles may be included in the compositions to provide or enhance hardcoat performance. The transparent polymeric hardcoats generally include up to about 10 wt % of the antimicrobial metal salts and can have a thickness of from about 1 micron to about 200 microns. For display applications, it is desirable for the hardcoat surface to have a large water contact angle, for example, of at least about 90°.

The transparent polymeric hardcoats may be disposed on a transparent substrate suitable for use in optical applications. The transparent substrate may be flexible or have rigidity depending on the particular application in which the transparent polymeric hardcoat is used. Polymeric films such as colorless polyimide substrates are particularly useful as substrates, as are touch sensitive displays. The transparent substrate may be glass. In some embodiments, the transparent polymeric hardcoat in combination with the transparent substrate generally provide a transparent optical film having selected optical properties such as a total transmittance of at least about 85%, and a haze value of no more than about 1.0%. For some applications, the transparent polymeric hardcoat in combination with the transparent substrate may have a CIELAB color b* no more than about 2.

In one aspect, the invention pertains to a coating composition comprising from about 0.025 wt % to about 90 wt % polymeric precursor, from about 0.005M to about 1M antimicrobial metal salt, and organic solvent.

In a further aspect, the invention pertains to a transparent optical film comprising an antimicrobial hardcoat layer disposed on a transparent substrate, wherein the antimicrobial hardcoat layer comprises antimicrobial metal ions.

In another aspect, the invention pertains to a touch screen comprising a substrate; a touch sensor supported by the substrate, and an antimicrobial hardcoat layer disposed over and substantially covering the touch sensor, wherein the antimicrobial hardcoat layer comprises antimicrobial metal ions.

### BRIEF DESCRIPTION OF THE DRAWINGS

FIG. 1 is a photograph showing microbial growth on bare Taimide® TPI polyimide film and for a transparent polymeric hardcoat not including antimicrobial metal salt.

FIG. 2 is a photograph showing microbial growth on transparent polymer hardcoats formed on Kolon CPI™ polyimide film. The photograph shows a hardcoat including copper nitrate, a hardcoat including silver perchlorate, and a control hardcoat that does not include antimicrobial metal salt.

FIG. 3 is a photograph showing microbial growth on transparent polymer hardcoats formed on Taimide® TPI polyimide film. The photograph shows a hardcoat including silver hexafluoroantimonate and a control hardcoat that does not include antimicrobial metal salt.

FIG. 4 is a photograph showing antimicrobial efficacy for transparent polymer hardcoats formed on Taimide® TPI polyimide film. The photograph shows a hardcoat including silver trifluoroacetate and a hardcoat including silver hexafluoroborate.

FIG. 5 is a photograph showing microbial growth and antimicrobial efficacy for transparent polymer hardcoats formed on Taimide® TPI polyimide film. The photograph shows a hardcoat including copper trifluoroacetylacetonate, a hardcoat including copper (II) chloride, and a hardcoat including copper hexafluoroacetylacetonate.

### DETAILED DESCRIPTION

Transparent polymer hardcoats have been developed that can provide desirable antimicrobial activity on their surface without significantly diminishing the physical or optical properties of the hardcoats. Specifically, desirable metal salts can be identified with suitable solubility in the solvents useful for the deposition of the hardcoats while exhibiting effective antimicrobial activity. The hardcoats can provide suitable optical properties at appropriate thicknesses for use in displays for commercial deployment in devices intended for high consumer use. Suitable hardcoats are generally highly crosslinked polymers selected with high optical transmission, low haze and high clarity.

The hardcoat layers can be designed to provide mechanical protection to the screens as well as to provide appropriate protections for the internal components from contaminants and the like. As the name implies, the layers can be scratch resistant due to chemical cross-linking, and by inclusion of various particles or additives. The thickness of the hardcoat layer can be selected to provide a desired level of protection accounting for any other issues related to the practical application. For convenience, the coating thickness refers to a dry, cured coating thickness. Generally, the hardcoat layers can be from about 1 micron to 200 microns, in further embodiments from about 1.5 microns to about 100 microns, in additional embodiments from about 2 microns to about 50 microns, and in other embodiments from about 2.5 microns to about 50 microns. For display applications, it is desirable for the hardcoat surface to have a large water contact angle, which indicates that the surface has a high propensity to repel water. In some embodiments, the hardcoat surface can exhibit a water contact angle of at least about 90°, in further embodiments at least about 110°, and in other embodiments at least about 112.5°. A person of ordinary skill in the art will recognize that additional ranges of thickness and water contact angle within the explicit ranges above are contemplated and are within the present disclosure.

The antimicrobial hardcoat materials comprise a hardcoat composition and a silver salt and/or copper salt. The metal salts are selected to be soluble in an organic solvent suitable for dissolving the polymer hardcoat precursor compositions. Solubility refers to solubility in the solvent used for the precursor hardcoat solution. The Examples are based on propylene glycol methyl ether (PGME), an organic solvent generally suitable for hardcoat precursor compositions. Correspondingly, the salts can be selected to not alter the optical properties significantly as well as providing desired antimicrobial properties. Antimicrobial metal ions include, for example, Ag⁺ and Cu⁺², and effective soluble antimicrobial salts include, for example, silver trifluoroacetate, silver tetrafluoroborate, silver hexafluoroantimonate, silver hexafluorophosphate, copper (II) nitrate, copper (II) hexafluoroacetylacetonate, and mixtures thereof.

Hardcoat compositions can comprise particulates that improve mechanical properties, such as scratch resistance, while not degrading significantly the optical properties. For example, some hardcoat compositions can comprise silica nanoparticles, as described in published U.S patent application 2016/0208130 to Ishikawa et al. (hereinafter the '130 application), entitled “Hard Coat Film,” and/or nanodiamonds, as described in U.S. patent application 2016/0096967 to Virkar et al., entitled “Property Enhancing Fillers for Transparent Coatings and Transparent Conductive Films,” both of which are incorporated herein by reference. Generally, the hardcoats can have no more than about 5 weight percent particulate fillers, in further embodiments no more than about 3 wt % and in other specific embodiments from about 0.001 wt % to about 1 wt % particulate fillers. A person of ordinary skill in the art will recognize that additional ranges within the explicit ranges above are contemplated and are within the present disclosure.

The hardcoat compositions generally comprise suitable classes of radiation curable polymers and/or heat curable polymers. These classes include, for example, polysiloxanes, polysilsesquioxanes, polyurethanes, acrylic resins, acrylic copolymers, cellulose ethers and esters, nitrocellulose, other water insoluble structural polysaccharides, polyethers, polyesters, polystyrene, polyimide, fluoropolymer, styrene-acrylate copolymers, styrene-butadiene copolymers, acrylonitrile butadiene styrene copolymers, polysulfides, epoxy containing polymers, copolymers thereof, and mixtures thereof. Suitable commercial hardcoat coating compositions include, for example, coating solutions (such as SK1100 Series Hard Coat) from Dexerials Corporation (Japan), POSS® Coatings from Hybrid Plastics, Inc. (Mississippi, USA), silica filled siloxane coatings from California Hardcoating Company (California, USA), Acier® Hybrid Hard Coating Material from Nidek (Japan), Lioduras™ from TOYOCHEM (Japan), HC-5619 Hard Coat from Addison Clear Wave (IL, USA), and CrystalCoat UV-curable coatings from SDC Technologies, Inc. (California, USA).

Polyacrylates can be effectively used to form highly crosslinked polymers. The acrylates polymerize based on vinyl groups with the reaction driven by free radical processes. Two bonds can form from a vinyl group along the polymer backbone, but two or more acrylate groups on a monomer can crosslink the resulting polymer. Ultraviolet light (UV) free radical initiators can be used to drive the crosslinking with UV light treatment following the drying of a coated layer of the hardcoat precursor composition. In the desirable hardcoats, a highly crosslinked acrylate component can be formed in some embodiments using highly branched acrylate monomers. Acrylates generally have good mechanical strength and can have good optical transparency.

In addition to or as an alternative to other acrylate monomers, pendant acrylate groups can be placed on urethane oligomers to effectively introduce urethane properties to the product hard coatings. The urethane acrylate polymerizes with the other acrylate contributing components for incorporation into the polymerized acrylate network. In these embodiments, the cured coating comprises urethane oligomer moieties, having carbamate linkages, within the polymer networks. Polyurethane moieties can be desirable in embodiments in which a higher resiliency is desired. For embodiments to obtain a desirably clear coating, the urethane oligomers can be free of aromatic groups, e.g., the hydrocarbon chains can be aliphatic.

Epoxy polymers can also provide good mechanical strength. Epoxies can involve polymerization reactions involving an epoxide functional group and optionally active hydrogen atoms, such as in a hydroxide group or a primary or secondary amine. The epoxide functional groups can self polymerize, and a cationic UV activated catalyst can be used to initiate the self-polymerization process. For polymerization, monomers with multiple functional groups are appropriate. The epoxide functional group is a three member cyclic ether with two carbon atoms on vertices of the ring. The polymerization of epoxide functional groups generally produces ether moieties. In some embodiments, epoxy monomers can be diglycidyl ethers of alkyl glycols.

In some embodiments, in addition to or as an alternative to other epoxy monomers, the epoxide groups can be situated on polysiloxane moieties. The polysiloxane moieties can be polysiloxane cage structures with an epoxide functional group linked to selected vertices of the cage. The cage structures provide for curing to form a highly branched polymer structures around the siloxane cage. Alternatively, other polysiloxane compounds modified with epoxide functional groups can be used as reactants. The polysiloxane cage structures with the epoxide functional groups can be conveniently processed with the solvent systems compatible with the other hardcoat components. However, polysiloxanes generally can be hydrophobic and can repel water. It can be desirable in some uses to reduce water interaction with the films protected by the hardcoating. Crosslinking agent and/or catalysts can be included in the hardcoat precursor solutions to facilitate the crosslinking process. For example, the precursor solution can comprise, radical catalysts and/or cation catalysts. Commercially available radical catalysts include, for example, the IRGACURE® line of photoinitiators from BASF, such as IRGACURE® 500 (blend of 1-hydroxy-cyclohexyl-phenyl-ketone and benzophenone), IRGACURE 651 (α, α-Dimethoxy-α-phenylacetophenone), IRGACURE 369 (2-Benzyl-2-dimethylamino-1 [4-(4-morpholinyl)phenyl]-1-butanone) and IRGACURE TPO (2,4,6-triethylbenzylphenylphosphinic acid ethyl ester), Doublecure series of photoinitiators from Double Bond Chemical Ind., Co., Ltd. (Taiwan) such as Doublecure TPO, Doublecure 184, Doublecure 575, and Doublecure 200, and the Omnirad series of photoinitiators available from IGM Resins, such as Omnirad 1000 (blend of 2-hydroxy-2-methyl-1-phenylpropanone and 1-hydroxy-cyclohexyl-phenyl-ketone). Suitable cationic catalysts, which can facilitate epoxy crosslinking, can be include, for example, diaryliodonium salts that have the structure [Ar—I—Ar]+X⁻, where Ar corresponds with an aryl group. Commercial cationic catalysts are available, for example, from Polyset (Mechanicville, N.Y., USA), IGM Resins USA, Inc. (IL, USA), and Chitec Technology Corp. (Taiwan). In some embodiments, the precursor solution can comprise crosslinking catalyst(s) and/or other crosslinking agents from about 0.1 weight percent to about 15 weight percent, in further embodiments from about 0.2 weight percent to about 13.5 weight percent and in other embodiments from about 0.25 weight percent to about 12 weight percent or radical catalyst as a fraction of the residue content of the precursor solution. A person of ordinary skill in the art will recognize that additional ranges of crosslinking catalyst(s) and/or other crosslinking agent concentrations within the explicit ranges above are contemplated and are within the present disclosure.

Further discussion of polymer components for hardcoats are described in the '130 application cited above and in published U.S. patent application 2016/0369104 to Gu et al., entitled “Transparent Polymer Hardcoats and Corresponding Transparent Films,” incorporated herein by reference.

Formation of the hardcoats generally involves a solution coating of a precursor solution followed by drying and curing steps. For the precursor solutions, the polymer concentrations and correspondingly the concentrations of other non-volatile agents can be selected to achieve desired rheology of the coating solution, such as an appropriate viscosity for the selected coating process. Solvent can be added or removed to adjust total solid concentrations. Relative amounts of solids can be selected to adjust the composition of the finished coating composition, and the total amounts of solids can be adjusted to achieve a desired thickness of the dried coating. Generally, the coating solution can have a polymer concentration from about 0.025 wt % to about 90 wt %, in further embodiments from about 0.05 wt % to about 85 wt % and in additional embodiments from about 0.075 wt % to about 80 wt %. The coating solution further comprises the antimicrobial metal salt generally in a concentration from about 0.005M to about 1M, in further embodiments form about 0.01M to about 0.85M and in additional embodiments from about 0.02M to about 1.00 M. A person of ordinary skill in the art will recognize that additional ranges of polymer concentrations and antimicrobial metal salt concentrations within the specific ranges above are contemplated and are within the present disclosure.

Solvents can be identified in the precursor solution based on some volatility at room temperature. Since the solvents are volatile and the hardcoat precursor is dried prior to curing, it is expected that the solvent does not participate in the polymerization/crosslinking reactions. Solvents are generally organic and selected to dissolve the polymer precursor compositions as well as the antimicrobial metal salts. Solvent blends can be useful. Suitable organic solvents include, for example, aromatic solvents, such as toluene, alkanes, such as hexane, alcohols, such as isopropyl alcohol, ketones, such as methylethyl ketone, esters, such as ethyl acetate, ethers, such as glycol ethers, or mixtures thereof. Glycol ethers include, for example, ethylene glycol monomethyl ether, ethylene glycol monoethyl ether, propylene glycol monomethyl ether, or the like, or combinations thereof. Solvent blends can be used to accommodate the requirement of metal salt solubility. The other components of the precursor solution besides the solvents can be collectively referred to as the solid content.

The hardcoat is generally coated over a transparent polymer substrate. The resulting structure may comprise additional layers that can provide functionality and/or structural/processing contributions. For example, transparent touch sensors can be used to convert the display into a touch sensitive display, and thus the transparent touch sensor provides functionality. A transparent adhesive can provide for securing the structure onto a device. Aspects of touch sensor structures are described further in copending U.S. patent application Ser. No. 16/259,302 to Chen et al., entitled “Thin Flexible Structures With Surfaces With Transparent Conductive Films and Processes for Forming the Structures,” and published patent application 2019/0364665 to Yang et al., entitled “Silver-Based Transparent Conductive Layers Interfaced With Copper Traces and Methods for Forming the Structures,” both of which are incorporated herein by reference.

In general, the polymer substrate can have any suitable thickness and composition, but certain applications generally provide preferences for the substrate. For many display applications, the polymer substrates generally can have average thicknesses of no more than about 150 microns, in further embodiments from about 1 micron to about 100 microns, in other embodiments from about 5 microns to about 80 microns, in some embodiments from about 5 microns to about 60 microns. For flexible electronics, the substrate generally has a thickness of no more than about 50 microns. The hardcoat can generally comprise form about 0.02 wt % to about 10 wt % metal ions, in further embodiments from about 0.05 wt % to about 5 wt % and in other embodiments form about 0.1 wt % to about 2 wt % antimicrobial metal ions. A person of ordinary skill in the art will recognize that additional ranges of thicknesses and metal ion concentrations within the explicit ranges above are contemplated and are within the present disclosure.

Suitable optically clear polymers with very good transparency, low haze and good protective abilities can be used for the substrate. Suitable polymers include, for example, polyethylene terephthalate (PET), polyethylene naphthalate (PEN), polyacrylate, poly(methyl methacrylate), polyolefin, polyvinyl chloride, fluoropolymers, polyamide, polyimide, polysulfone, polysiloxane, polyetheretherketone, polynorbornene, polyester, polystyrene, polyurethane, polyvinyl alcohol, polyvinyl acetate, acrylonitrile-butadiene-styrene copolymer, cyclic olefin polymer, cyclic olefin copolymer, polycarbonate, copolymers thereof or blend thereof or the like. Suitable commercial polycarbonate substrates include, for example, MAKROFOL SR243 1-1 CG, commercially available from Bayer Material Science; TAP® Plastic, commercially available from TAP Plastics; and LEXAN™ 8010 CDE, commercially available from SABIC Innovative Plastics. Some specific suitable polymers include, for example, polysulfide (such as Pylux™, Ares Materials), polysulfone (such as Udel® from Solvay), or polyethersulfone (such as Veradel® from Solvay or Ultrason® from BASF), and polyethylene naphthalate (such as Teonex® from DuPont). Examples are presented below based on transparent polyimides or PET. Traditional aromatic polyimides are colored. But recently developed polyimides can be transparent to visible light. The transparent polyimides absorb ultra violet light. Transparent polyimides are available from Kolon (Korea), Taimide Tech. (Taiwan), Sumitomo (Japan), SKC Inc. (GA, USA) and NeXolve (AL, USA).

The transparent structure with the hardcoat generally has desirable optical properties with respect to high transmittance of visible light, low haze and little color. These optical properties can be measured, for example, with a hazemeter and/or a spectrophotometer, which can be configured to measure color parameters in the CIELAB color space. Color spaces can be defined to relate spectral wavelengths to human perception of color. CIELAB is a color space determined by the International Commission on Illumination (CIE). The CIELAB color space uses a three-dimensional set of coordinates, L*, a* and b*, where L* relates to the lightness of the color, a* relates to the position of the color between red and green, and b* relates to the position of the color between yellow and blue. The “*” values represent normalized values relative to a standard white point. The antimicrobial salts can result in a slight increase of b*. In some embodiments, it can be desirable for the absolute value of b* for the transparent structure to be no more than 2.0, in further embodiments no more than 1.75 and in additional embodiments no more than a value of 1.5. A person of ordinary skill in the art will recognize that additional ranges of b* within the explicit ranges above are contemplated and are within the present disclosure.

Transmittance is the ratio of the transmitted light intensity (I) to the incident light intensity (Iₒ). The transmittance through the hardcoat (T_{H}C) can be estimated by dividing the total transmittance (T) measured by the transmittance through the substrate (T_{sub}). (T=I/Iₒ and T/T_{sub}=(I/Iₒ)/(I_{sub}/Iₒ)=I/I_{sub}=T_{HC}) Thus, the reported total transmissions can be corrected to remove the transmission through the substrate to obtain transmissions of the hardcoat alone, if desired, but results in the examples are TT % through the substrate and hardcoat. Transmission can be reported as total transmittance (TT) from 400 nm to 700 nm wavelength of light, and such results are reported in the Examples below. It is desirable for the transparent structures to have low haze, which relates to the scattering of light, which can give a hazy appearance to an observer. Transmittance and haze of the transparent structures can be evaluated using the standard ASTM D1003 (“Standard Test Method for Haze and Luminous Transmittance of Transparent Plastics”), incorporated herein by reference. In some embodiments, the film formed by the fused network has a total transmittance (% TT) of at least 85%, in further embodiments at least about 87.5%, in additional embodiments, at least about 89%, in other embodiments at least about 90% and in some embodiments at least about 91%. In some embodiments, the transparent structure can have a haze value of no more than about 2%, in further embodiments no more than about 1.5%, and in additional embodiments no more than about 1.0%. If desired, the haze contribution of the substrate can be removed to provide haze values of the hardcoat. For some antimicrobial salts, the haze is observed to decrease relative to the substrate without a hardcoat. A person or ordinary skill in the art will recognize that additional ranges of transmittance or haze within the explicit ranges above are contemplated and are within the present disclosure.

Antimicrobial efficacy can be evaluated using any appropriate procedure. In the examples below, efficacy against bacteria are tested by placing samples in a petri dish and incubating under conditions conducive to bacterial growth. Several of the salts inhibit bacterial growth, while preserving high water contact angles, and a subset of these antimicrobial salts are also found to maintain optical properties in a desirable range. It is expected that the antimicrobial salts will also have efficacy with respect to anti-viral activity. For example, copper surfaces have been observed to be effective to quickly lower the loading of viable SARS-COV-2 viruses, which cause the COVID-19 illness.

Any reasonable deposition process can be used to deposit the hardcoat precursor solution. Suitable coating or printing approaches can include, for example, spin coating, slot coating, knife edge coating, gravure printing, spray coating, or the like. Slot coating is frequently used for display production, and the Examples herein use slot coating. The wet coating thickness can be selected to achieve a desired dry coating thickness.

The deposited hardcoat precursor solution can be dried to remove the solvent. Again, any reasonable drying approach can be used. For a commercial coating line, warm air can be blown across the coated substrate to remove solvent. To crosslink the hardcoat, UV light can be used, although some hardcoat materials can be thermally crosslinked. The crosslinking may be at least partially combined with the drying process. For UV crosslinking, suitable UV lamps can be used.

### Examples

Samples were prepared of hardcoats loaded with metal salts to test the properties of the resulting structures. Three different substrates and two different hardcoat compositions were used, and it is believed that the substrates did not alter the antimicrobial efficacy. The percent total transmission (% TT) and haze value of the film samples were measured using a haze meter. CIELAB values for b* were determined using commercial software from measurements made with a Konica Minolta Spectrophotometer CM-3700A with SpectraMagic™ NX software. Replicated water contact angle (WCA) measurements were performed using Attension Theta Optical Tensiometer and the OneAttension software. Precursor solutions had a hardcoat solids concentration in PGME solvent of about 40 wt % and a metal salt concentration of about 0.1M. The hardcoats were coated to have a dry thickness of 5 to 10 microns.

Antimicrobial testing was performed on potato dextrose agar from VWR International, LLC. The agar plates were first inoculated with bacteria via mouth swab. Coated films were then cut into 1″×1″ squares and placed coating side down onto the agar plates. The agar plates were then incubated at 40° C. in a humidity chamber for 72 hours. Afterwards, the plates were visually inspected for bacterial colony growth around and under the sample films.

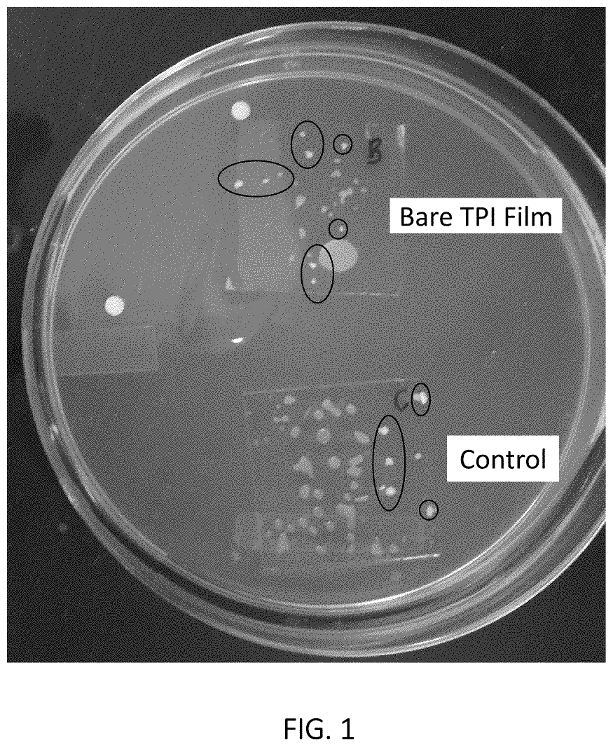

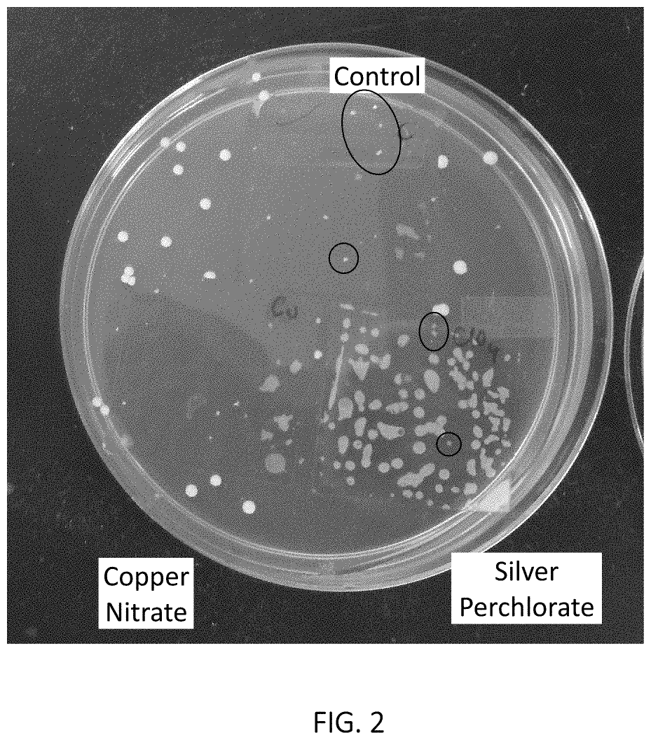

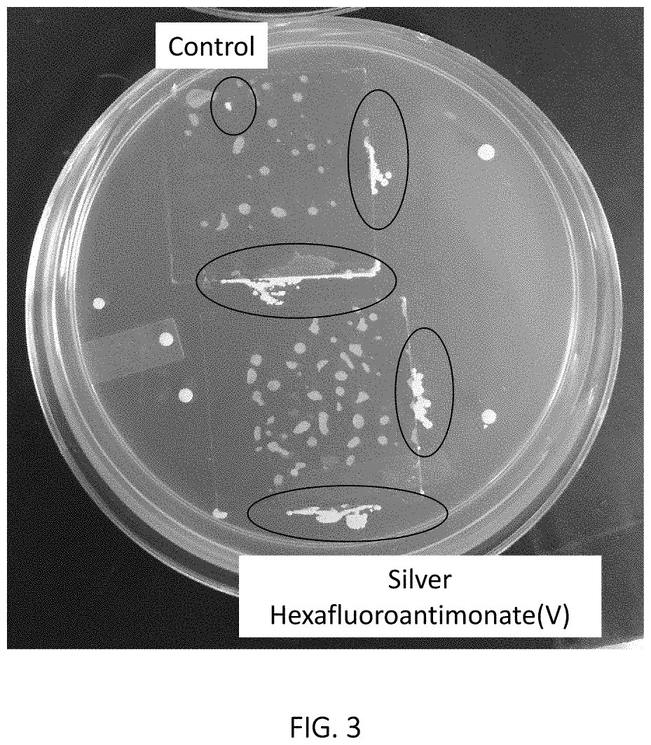

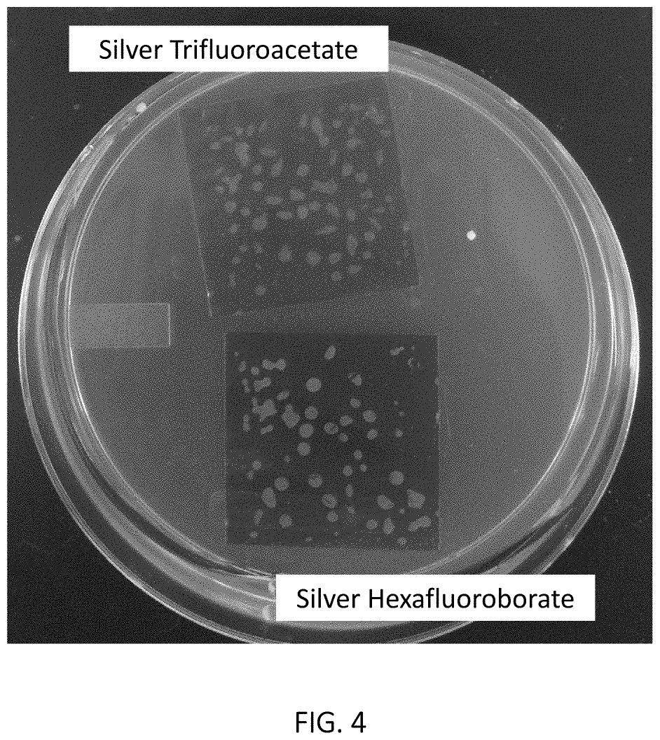

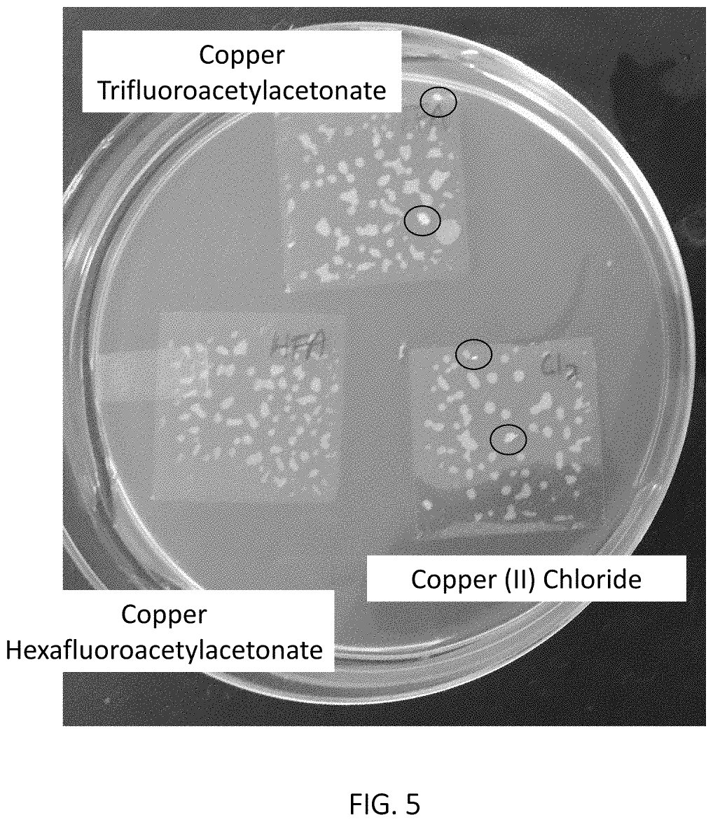

A first set of samples were formed on a colorless polyimide film Kolon CPI™ from Kolon Industries. A second set of samples were formed on Taimide® TPI polyimide film from Taimide Tech, Inc. A third set of samples were formed on 23 micron PET from Toray Industries, Inc. Three sets of highly crosslinked polyacrylate with other polymer components from Dexerials Corporation were selected as the base resin systems. The optical, water contact angle (WCA), and antimicrobial results are summarized in the Table. FIGS. 1-5 are photographs of the transparent polymer hardcoats prepared in petri dishes and used to evaluate the antimicrobial effectiveness. Markings are drawn around bacterial colonies that grew on samples. From these results some metal salts provided antibacterial efficacy while maintaining desirable optical properties and high water contact angles.

TABLE 1

| | | % | Haze | | WCA | Bacterial |
|---|---|---|---|---|---|---|
| Antimicrobial Agent | Substrate | TT | (%) | b* | (°) | Growth |
| Control | Kolon | 92.3 | 0.58 | 0.91 | 115.5 | Yes |
| | CPI | | | | | |
| Silver | Kolon | 91.5 | 0.88 | 1.54 | 115.3 | Yes |
| Perchlorate | CPI | | | | | |
| Copper (II) | Kolon | 91.5 | 0.58 | 1.78 | 112.3 | No |
| Nitrate | CPI | | | | | |
| Control | Taimide | 92.2 | 0.30 | 0.84 | 116.2 | Yes |
| | TPI | | | | | |
| Silver | Taimide | 82.1 | 0.31 | 25.83 | 117.0 | No |
| Trifluoroacetate | TPI | | | | | |
| Silver | Taimide | 85.6 | 1.61 | 16.06 | 116.4 | No |
| Tetrafluoroborate | TPI | | | | | |
| Silver | Taimide | 92.1 | 3.44 | 1.18 | 116.2 | No |
| Hexafluoroborate | TPI | | | | | |
| Copper (II) | Taimide | 91.6 | 0.25 | 1.09 | 116.2 | Yes |
| Trifluoroacetyl- | TPI | | | | | |
| acetonate | | | | | | |
| Copper (II) | Taimide | 92.1 | 0.22 | 1.17 | 114.6 | No |
| Hexafluoroacetyl- | TPI | | | | | |
| acetonate | | | | | | |
| Copper (II) | Taimide | 91.7 | 1.68 | 1.30 | 114.7 | Yes |
| Chloride | TPI | | | | | |
| Control | Toray | 92.6 | 0.07 | 0.51 | 112.8 | Yes |
| | PET | | | | | |
| Copper (II) | Toray | 92.6 | 0.06 | 0.74 | 113.5 | No |
| Hexafluoroacetyl- | PET | | | | | |
| acetonate | | | | | | |

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art.

What is claimed is:

1. A coating composition comprising:
from about 0.025 wt % to about 90 wt % polymeric precursor,
from about 0.005M to about 1M antimicrobial metal salt, and
organic solvent.

2. The coating composition of claim 1, the antimicrobial metal salt comprising Ag⁺.

3. The coating composition of claim 1, the antimicrobial metal salt comprising Cu⁺².

4. The coating composition of claim 1, the antimicrobial metal salt comprising copper (II) nitrate, silver trifluoroacetate, silver tetrafluoroborate, silver hexafluoroantimonate or combinations thereof.

5. The coating composition of claim 1, the antimicrobial metal salt comprising copper (II) hexafluoroacetylacetonate.

6. The coating composition of claim 1, the polymeric precursor comprising UV curable acrylates.

7. The coating composition of claim 1, the polymeric precursor comprising urethane oligomers having acrylate functionality.

8. The coating composition of claim 1, the polymeric precursor comprising diglycidyl ethers of alkyl glycols.

9. The coating composition of claim 1, the polymeric precursor being free of aromatic groups.

10. The coating composition of claim 1, the organic solvent comprising aromatic solvents, alkanes, alcohols, ketones, esters, ethers, or mixtures thereof.

11. The coating composition of claim 1, further comprising silica nanoparticles.

12. The coating composition of claim 1, further comprising nanodiamonds.

13. A transparent optical film comprising:
an antimicrobial hardcoat layer disposed on a transparent substrate, wherein the antimicrobial hardcoat layer comprises antimicrobial metal ions.

14. The transparent optical film of claim 13, the transparent substrate comprising a polyimide.

15. The transparent optical film of claim 13, the antimicrobial hardcoat layer further comprising from about 0.001 wt % to about 1 wt % nanoparticles.

16. The transparent optical film of claim 13, an outermost surface of the antimicrobial hardcoat layer exhibiting a water contact angle of at least about 112.5°.

17. The transparent optical film of claim 13, the hardcoat layer having a thickness of from about 2.5 microns to about 50 microns.

18. The transparent optical film of claim 13, having a b* no more than about 1.5, total transmittance of at least about 85%, and a haze value of no more than about 1.0%.

19. The transparent optical film of claim 13 wherein the antimicrobial metal ions comprise copper (+2) ions.

20. The transparent optical film of claim 13 wherein the animicrobial hardcoat layer comprises from about 0.02 wt % to about 10 wt % antimicrobial metal ions.

21. A touch screen comprising:
a substrate;
a touch sensor supported by the substrate, and
an antimicrobial hardcoat layer disposed over and substantially covering the touch sensor, wherein the antimicrobial hardcoat layer comprises antimicrobial metal ions.
